(19) United States
(12) Patent Application Publication
(10) Pub. No.: US 2008/0040757 A1
(43) Pub. Date: Feb. 14, 2008

(54) Video content streaming through a wireless access point

(76) Inventors: David Romano, Cumberland, RI (US); Xiancheng Yuan, Acton, MA (US); Bapi Vinnakota, Fremont, CA (US); Liang-Min Wang, Northborough, MA (US); Yogesh Bansal, Marlborough, MA (US)

Correspondence Address: INTEL CORPORATION;c/o INTELLEVATE, LLC, P.O. BOX 52050, MINNEAPOLIS, MN, 55402, US

(21) Appl. No.: 11/496,531

(22) Filed: Jul. 31, 2006

(51) Int. Cl. H04N 7/18

(52) U.S. Cl. 725/81

(57) ABSTRACT

A method that includes streaming video content at a given bit-rate from a computing platform through a wireless access point and to a digital media adaptor that decodes the video content for display. A communication channel used to stream the video content to the digital media adaptor is monitored and information associated with the communication channel as at least a portion of the video content is streamed from the computing platform to the digital media adaptor is collected. Available bandwidth for the communication channel is determined based on the collected information. An adjustment to the given bit-rate that another portion of the video content is streamed from the computing platform is made based on the available bandwidth.

### BACKGROUND

Multimedia networking (data, voice, video) is helping to drive adoption of a new class of Consumer Electronics (CE) that are interconnected via various types of networks (e.g., wired or wireless local area networks (LANs)). The streaming of video content on these types of networks is a desirable technology for a growing digital home entertainment market. But video content is among the most difficult types of data to reliably transmit or stream. The difficulty is likely increased when the video content is streamed using a communication channel that includes wireless and/or wired communication links in a residential setting.

A communication channel that may include one or more wireless communication links may interconnect one or more CEs to a computing platform. The computing platform may be able to stream the video content and may also maintain or at least temporarily store the video content. Video content may be streamed from the computing platform, through a wireless access point (AP) and then to a digital media adaptor (DMA) included in or coupled to a CE that includes a display (e.g., a television). The DMA, for example, decodes the received video content for display at the CE.

### BRIEF DESCRIPTION OF THE DRAWINGS

FIG. 1 is an illustration of elements of an example system to stream video content from a computing platform through a wireless AP and to a DMA;

FIG. 2A is an illustration of the system using a communication channel to stream video content that includes wired and wireless communication links;

FIG. 2B is an illustration of the system including wireless links to stream video content;

FIG. 3 provides a timing model to depict bandwidth utilization over a measurement time interval;

FIG. 4 is a flow chart on an example method to determine available bandwidth on a communication channel to indicate available bandwidth;

FIGS. 5A-C depict communication channels included as part of an example communication channel for bandwidth feedback between a computing platform and a wireless access point in the system;

FIGS. 6-8 are diagrams that depict example state machines executed by the wireless AP to establish and maintain the communication channel for bandwidth feedback;

FIGS. 9 and 10 are diagrams that depict example state machines executed by the computing platform to establish and maintain the communication channel for bandwidth feedback;

FIG. 11 illustrates an example message format for a computing platform to discover a wireless AP;

FIG. 12 illustrates an example message format for the computing platform to send control information to the wireless AP;

FIG. 13 illustrates an example message format for the wireless AP to send bandwidth feedback information to computing platform;

FIG. 14 is an illustration of the wireless AP and the computing platform implementing an example method to adjust the bit-rate that video content is streamed from the computing platform through the wireless AP to the DMA; and

FIG. 15 is an illustration of an example residential network.

### DETAILED DESCRIPTION

As mentioned in the background, video content is among the most difficult content to reliably transmit over a communication channel that includes one or more wireless and/or communication links. The technical barriers of streaming video content are numerous, for example, shared/limited bandwidth, best effort delivery, transmission errors, dropped video frames, delays, out of sync video with voice, etc. A typical residential network (although this disclosure is not limited to only residential networks) may operate according to various industry standards for wired local area networks (LAN) and/or for wireless local area networks (WLAN). Such industry standards may include, but are not limited to, industry standards associated with or sponsored by the Institute for Electrical and Electronic Engineers (IEEE). These industry standards may enable the efficient exchange of types of data that is not timing sensitive. However, the components of a typical residential network (e.g., computing platforms, wireless APs, etc.) are not well suited or configured for types of data that is timing sensitive (e.g., streaming of video content including associated audio content) even when operating according to LAN or WLAN industry standards.

In one example, video content is streamed at a given bit-rate from a computing platform through a wireless AP and to a DMA that decodes the video content for display. A communication channel that is used to stream the video content to the digital media adaptor is monitored to collect information associated with the communication channel as at least a portion of the video content is streamed from the computing platform. Available bandwidth for the communication channel is determined based on the collected information. The given bit-rate another portion of the video content is streamed from the computing platform is adjusted based on the available bandwidth.

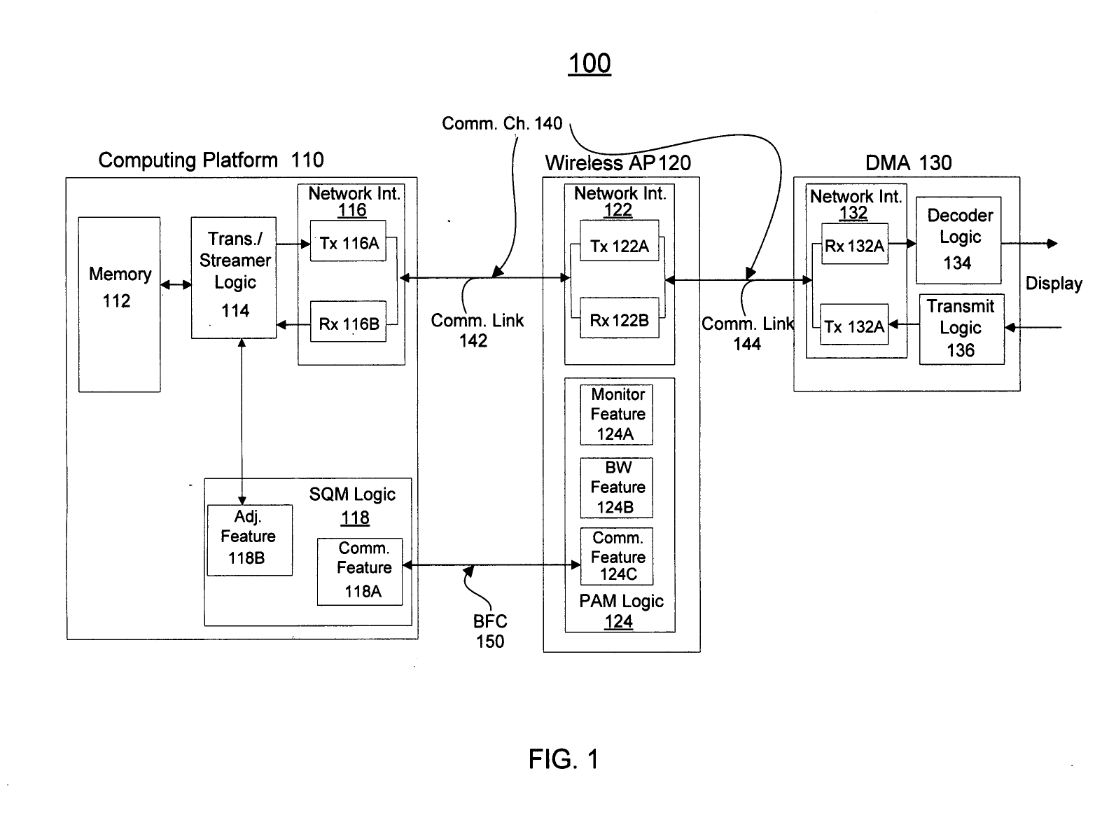

FIG. 1 is an illustration of elements of an example system 100 to stream video content from a computing platform through a wireless access point (AP) and to a digital media adaptor (DMA) that decodes the video content for display. In one example, as depicted in FIG. 1, system 100 includes computing platform 110, wireless AP 120 and DMA 130. These elements, for example, use communication channel 140 to stream video content from computing platform 110 through wireless AP 120 and to DMA 130. As described in more detail below, a bandwidth feedback channel (BFC) 150 between computing platform 110 and wireless AP 120 is used, for example, to relay available bandwidth information for streaming the video content via communication channel 140.

As shown in FIG. 1, in one example, computing platform 110 includes memory 112, transcoder/streamer logic 114, network interface 116 and stream quality manager (SQM) logic 118 each coupled as depicted. Memory 112 (e.g., a hard drive or other storage device responsive to computing platform 110), for example, at least temporarily stores video content. This video content, for example, is transcoded into blocks of data (e.g., packets) by transcoder/streamer logic 114 at a given bit-rate (e.g., 2 Mega bits per second (2 Mbits/sec)) and then forwarded from computing platform 110 through network interface 116. Prior to forwarding transcoded video content from computing platform 110, a portion (e.g., one or more packets) of the video content is at least temporarily stored in transmit (Tx) buffer 116A included in or responsive to network interface 116.

In one example, transcoder/streamer logic 114 may transcode and stream the video content in compliance with one or more industry standards for transcoding and/or compressing images included in the video content. These industry standards may include, but are not limited to, the Motion Picture Expert Group (MPEG) standards published by the International Organization for Standardization (ISO)/International Electrotechnical Commission (IEC). The MPEG standards include: ISO/IEC 11172:1993, Information technology—Coding of Moving Pictures and Associated Audio for Digital Storage Media at up to about 1.5 Mbits/sec, published in 1993, and/or later versions (“MPEG-1”); ISO/IEC 13818:2000, Information technology—Generic Coding of Moving Pictures and Associated Audio Information, published in 2000, and/or later versions (“MPEG-2”); and ISO/IEC 14496:2004, Information technology—Coding of Audio-Visual Objects, published in 2004, and/or later versions (“MPEG-4”).

In one implementation, the video content is streamed via communication channel 140 to DMA 130. Communication channel 140, for example, includes communication links 142 and 144. In one implementation, communication links 142 and 144 may include duplex or two-way (transmit and receive) wired and wireless links. The video content, for example, is first forwarded over communication link 142 to wireless AP 120 and then forwarded from wireless AP 120 to DMA 130 over communication link 144.

In one example, wireless AP 120 includes network interface 122 to facilitate the streaming of video content received from computing platform 110 over communication link 142 and then to DMA 130 over communication link 144. Network interface 122, for example, includes or has access to Tx buffer 122A and Rx buffer 122B to at least temporarily store the video content as the video content is received from computing platform 110 and before it is forwarded to DMA 130. Wireless AP 120, for example, also includes proactive air management (PAM) logic 124. PAM logic 124, for example, includes features to monitor the streaming of the video content via communication channel 140, determine and/or estimate the available bandwidth to stream the video content via communication channel 140 and then indicate that available bandwidth for communication channel 140 to computing platform 110.

In one implementation, BFC 150 is established, maintained and used to communicate or indicate available bandwidth for communication channel 140. In one example, BFC 150 is established and maintained using either wired or wireless communication links between computing platform 110 and wireless AP 120. Although not shown in FIG. 1, both computing platform 110 and wireless AP 120 may include LAN and WLAN logic (e.g., hardware, firmware and/or software) to communicate over these wired or wireless communication links. In one example, BFC 150 is a sideband communication channel relative to the communication channel used to stream the video content, e.g., communication channel 140.

In one example, once BFC 150 is established, it is used by PAM logic 124 to indicate available bandwidth to SQM logic 118. As shown in FIG. 1, SQM logic 118, for example is resident on computing platform 110. In one example, SQM logic 118 includes features to communicate with PAM logic 124 to send instructions for what to monitor and to receive results of that monitoring, e.g., available bandwidth. In one example, based on an indication of available bandwidth, features included in SQM logic 118 may cause transcoder/streamer logic 114 to adjust the given bit-rate that video content is streamed from computing platform 110 via communication channel 140.

In one implementation, the video content streamed to DMA 130 via communication channel 140 is received via communication link 144. In one example, DMA 130 includes network interface 132. Network interface 132, for example, includes or has access to receive (Rx) buffer 132A to at least temporarily store received video content. The received video content may then be forwarded to decoder logic 134. Decoder logic 134, for example, decodes or disassembles the packetized video content for display of the video content on one or more display devices. These display devices include, but are not limited to, plasma displays, liquid crystal displays (LCD), projection displays and cathode ray tube (CRT) displays. In one implementation, these types of displays may be part of a television or may be a monitor for a computing platform, although this disclosure is not limited to only displays in televisions or monitors.

In one example, DMA 130, as shown in FIG. 1, includes transmit logic 136. Transmit logic 136, for example, gathers and sends information back to computing platform 110 via communication channel 140. This information may include an indication to computing platform 110 to send more, less and/or different video content for DMA 130 to decode for display. For example, DMA 130 may send feedback information to indicate the level of resources available to receive and decode video content. This information may be used to adjust the bit-rate the video content is streamed. In another example, a user or viewer of video content displayed may have the ability (e.g., via a user interface coupled to the display device and/or DMA 130) to request different video content. This different video content, for example, may also be maintained in memory 112 or may be obtained by computing system 110 (e.g., via the Internet or other communication channel). In this other example, transmit logic 136 may handle the request for the different video content and relay that request back to computing platform 110 via communication channel 140.

In one implementation, information including an indication to send more or different video content is at least temporarily stored at Tx buffer 132B included in and/or responsive to network interface 132. The information is then forwarded to wireless AP 120 over communication link 144. Tx buffer 112A and Rx buffer 122B, for example, at least temporarily store at least portions (e.g., one or more data packets) of the information at wireless AP 120 before it is forwarded on to computing platform 110 via communication link 142. At computing platform 110, for example, Rx buffer 116B at least temporarily stores the information as the information is then sent to transcoder/streamer logic 114. Transcoder/streamer logic 114, for example, transcodes and streams video content from memory 112 based at least in part on the information received from DMA 130. This streaming, for example, is at a given bit-rate that may be an adjustment to a previous given bit-rate. The given or adjusted bit-rate may also consider indications received from PAM logic 124 to determine adjustments to the bit-rate to stream the video content from computing platform 110.

In one example, PAM logic 124, monitors communication channel 140. As described more below, one or more features of PAM logic 124, for example, gather or collect information associated with the streaming of video content using communication channel 140. This associated information may include statistical information related to communication channel 140 and/or to certain aspects of transmit and receive portions of one or both communication links 142 and 144. The statistical information may also include network statistics, e.g., congestion, link bandwidth, peak/low traffic periods, constraining link(s), etc. Based on that collected information, the available bandwidth for communication channel 140 may be determined by features of PAM logic 124. That determination, for example, is communicated to computing platform 110 for an adjustment to the given bit-rate that video content is streamed from computing platform 110.

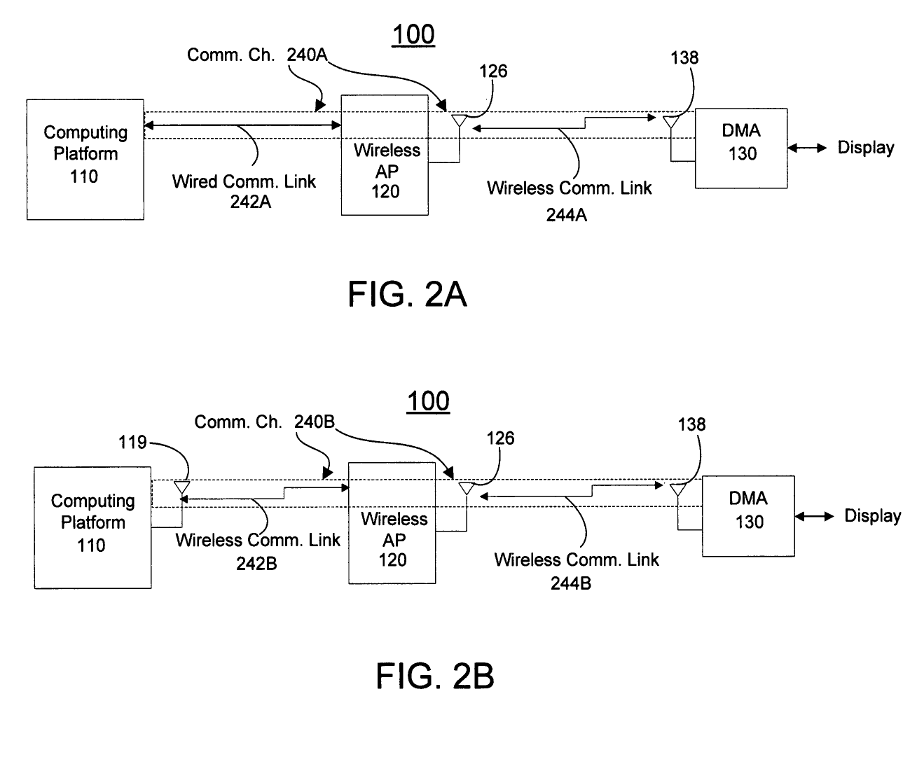

FIG. 2A and FIG. 2B illustrate examples of system 100 including both wired and wireless links to stream video content. In one example, as depicted in FIG. 2A, communication channel 240A includes a wired communication link 242A that couples computing platform 110 to wireless AP 120. In this example, computing platform 110 and wireless AP 120 include a network interface that operates in compliance with one or more industry standards for wired communication. One such industry standard is IEEE 802.3 standard for a CSMA/CD (Carrier Sense Multiple Access with Collision Detection) protocol. See IEEE 802.3-2002: IEEE Standard for Information technology—Telecommunications and information exchange between systems—Local and metropolitan area networks—Specific requirements Part 3: CSMA/CD Access Method and Physical Layer Specifications, published August 2002, and/or later versions of the standard (the “Ethernet standard” or “802.3 standard”).

In one implementation, communication channel 240A also includes a wireless communication link 244A as depicted in FIG. 2A. In another implementation, as depicted in FIG. 2B, communication channel 240B may include wireless communication links 242B and 244B to couple wireless AP 120 to computing platform 110 and to DMA 130. Computing platform 110, wireless AP 120 and DMA 130, for example, are shown as including antennae 119, 126 and 136, respectively. These antennae may each couple to a network interface and/or other component resident on computing platform 110, wireless AP 120 and DMA 130 to enable wireless capabilities (e.g., one or more radios, digital signal processors, etc.). These network interfaces may operate in compliance with one or more industry standards for wireless communications. One such industry standard is the IEEE Standard for Information technology—Telecommunications and information exchange between systems—Local and metropolitan area networks—Specific requirements Part 11: Wireless LAN Media Access Control (MAC) and Physical Layer (PHY) Specifications, published 1999, and/or later versions of the standard (the “802.11 standard”).

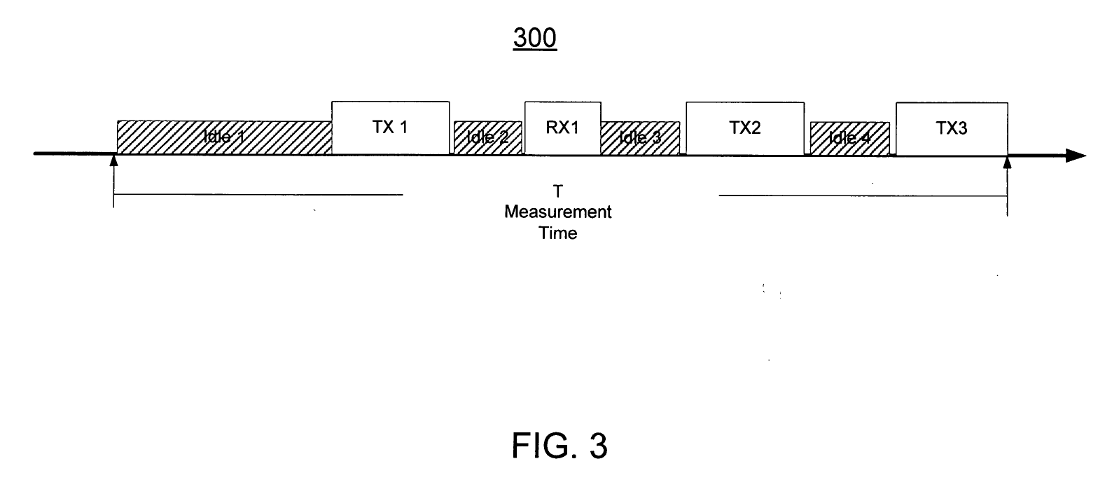

FIG. 3 provides a timing model 300 to depict bandwidth utilization over a measurement time interval. In one implementation, PAM logic 124 activates monitor feature 124A to monitor communication channel 140 for a given measurement time. Timing model 300 is an example of a timing model that is generated by monitor feature 124A and at least temporarily stored in a memory responsive to PAM logic 124.

In one implementation, over the given measurement time, at least three categories of information are tracked by monitor feature 124A: Transmit (Tx), Receive (Rx) and Idle time. The Measurement Time shown in FIG. 3, for example, is the time period, “T” in milliseconds, over which these events are monitored. Tx time, for example, is the time spent in transmission during “T” and includes the total time spent in the transmit sequences as defined by the wired or wireless protocols described in the applicable industry standards (e.g., IEEE 802.11, 802.3, etc.) that network interfaces coupled to communication links 142 and 144 operate in compliance with. Rx time, for example, is the time spent in reception during “T” and includes the total time spent in the receive sequences as defined by the wired or wireless protocols. The Idle time, for example, can be simply viewed as the Measure Interval minus the Tx-Time plus Rx-Time. A fourth category tracked by monitor feature 124A, for example, called Non-Idle time is the Tx-Time plus Rx-Time.

In one example, additional information or statistics are obtained or collected by monitor feature 124A. This additional information or statistics may include a transmit byte count (“Tx_byte count”). A Tx_byte count, for example, may include a byte count of successfully transmitted packets of video content and/or other information to DMA 130. In one example, the Tx_byte count does not include retransmissions. The additional information or statistics may also include a receive (Rx) byte count (“Rx_byte count”). An Rx_byte count, for example, is a byte count of successfully received packets of video content and/or other information received from computing platform 110 over the measurement time (e.g., as mentioned above). In one example, the Rx_byte count does not include packet drops.

Monitor feature 124A, for example, obtains the Tx_byte count and the Rx_byte count by monitoring network interface 122 and/or Tx and Rx buffer 122A. Network interface 122 may also include a media access controller (not shown) that monitor feature 124A may also monitor and obtain Tx_byte and/or the Rx_byte counts.

In one implementation, PAM logic 124 activates bandwidth feature 124 to determine available bandwidth for communication channel 140 to stream video content to DMA 130. Bandwidth feature 124, for example, obtains the timing model and/or the additional information mentioned above that was collected by monitor feature 124A and determines the available bandwidth, additional communication channel capacity for communication channel 140, or head room on the channel in bits/sec for video content to be streamed on communication channel 140 to DMA 130.

In one example, available bandwidth can be calculated by first calculating the effective rate for each direction (Tx & Rx) for the measurement period by taking the sum of the number of data bytes successfully transmitted/received. This calculation, for example, estimates the rate that was achieved in the Measurement Time “T”. Examples of the effective Tx rate and Rx rate are shown in Table 1. Also, since “T” is in milliseconds and counts are in bytes the values are divided by 1000 and multiplied by 8 to achieve bit/sec units

TABLE 1

Effective_Tx_Rate (bits/sec) = (((Tx_byte count)/Measurment
Time)/1000)*8
Effective_Rx_Rate (bit/sec) = (((Rx_byte count)/Measurment
Time)/1000)*8

The additional bandwidth (“Headroom_Rate” (bit/sec)) for communication channel 140, in this example, is then calculated by multiplying the Total Effective Rate (Effective_Tx_rate+Effective_Rx_rate) times the ratio of Idle_Time to Non_Idle_Time. An example of this calculation is shown in Table 2.

TABLE 2

Headroom_Rate (bit/sec) =
Total_Effective_Rate × (Idle_Time/Non_Idle_Time)

The Idle_time/Non_Idle_time in Table 2 above, for example, provides a de-rating factor and is used to more accurately determine what additional bandwidth can be achieved based on a performance of communication channel 140 to stream video content and to relay information between computing platform 110, wireless AP 120 and DMA 130. Additionally, for example, a tuning factor is also introduced to Non_Idle_Time that is used in the calculation shown in Table 2. An example of this tuning factor is shown in Table 3. This tuning factor, for example, possibly provides an even more accurate calculation of available bandwidth.

TABLE 3

```
Non_Idle_Time = Tx_Time +
    Rx_Time + (Protocol_Seq_OH_Time × Tx_byte count) +
    (Protocol_Seq_OH_Time × Rx_byte count)
```

The Protocol_Seq_OH_Time in Table 3 above, for example is used to compensate for the air time used in the transmission and receive sequences of frames of streamed video content that is not captured by the Tx_Time and Rx_Time measurement. This, for example, may be needed due to protocol sequence overhead associated with a given communication protocol (e.g., IEEE 802.11, 802.3, etc.) that is used to transmit/receive packets of video content or information on communication channel 140 and/or communication links included in communication channel 140.

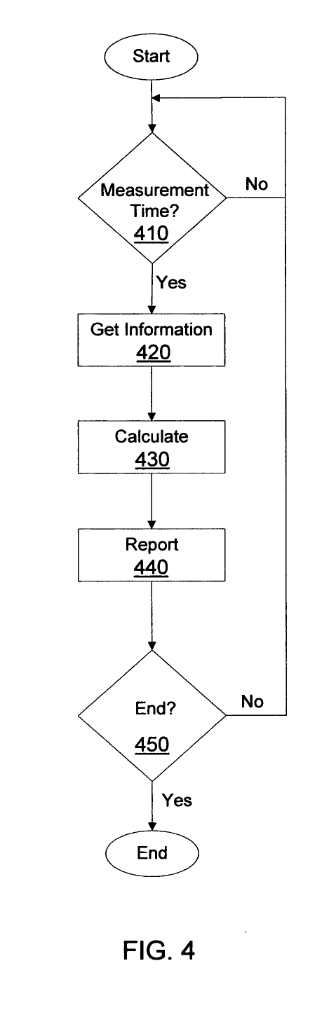

FIG. 4 is a flow chart on an example method to determine available bandwidth on communication channel 140 to indicate or report that available bandwidth. In one implementation, at block 410, monitor feature 124A is activated by PAM logic 124. Monitor feature 124A, for example, begins to collect or gather information about communication channel 140 to create a timing model similar to timing model 300 depicted in FIG. 3. As described above, in one example, a Measurement Time “T” is established and monitoring feature 124A may use a counter or type of timing device that is responsive to PAM logic 124 (not shown) to determine whether the measurement time was exceeded.

At block 420, in one example, monitoring feature 214A gathers, as described above, additional information or statistics that may include Tx_byte count and the Rx_byte count. Then at block 430, for example, PAM logic 124 activates bandwidth feature 124B. Bandwidth feature 124B, for example, obtains the timing model and/or the additional information mentioned above that was collected by monitor feature 124A and determines the available bandwidth, additional communication channel capacity for communication channel 140, or head room on the channel in bits/sec for video content to be streamed on communication channel 140 to DMA 130.

At block 440, in one example, PAM logic 214 activates communication feature 214C to report the calculated available bandwidth, additional communication channel capacity for communication channel 140, or head room on the channel in bits/sec for video content to be streamed on communication channel 140 to DMA 130. This reported information, for example is sent to computing platform 110. As described more below, this reporting occurs, for example, via BFC 150.

At block 450, in one example, PAM logic 214 determines whether video content is still streaming from computing platform 110. This determination may include, for example, an indication from computing platform 110 that video content is no longer being streamed and to stop monitoring communication channel 140. If no indications of stoppage are received, for example, the method moves back to block 410. If no packets have been transmitted within the given amount of time or an indication of stoppage is received the method is done until more or additional video content is streamed from a computing platform (e.g., computing platform 110) and through wireless AP 120.

In one implementation, the algorithm in Table 4 is implemented by the features of PAM logic 214 (e.g., monitor feature 214A, bandwidth feature 214B) to accomplish the method portrayed in the flow chart of FIG. 4.

```
TABLE 4
Calculate Channel Measurement time:
    Measurement_Time = Time-Current − Time-Last
Calculate Channel Non Idle time:
    Non_Idle_Time =
        Tx_Time + Rx_Time + (Protocol_Seq_OH_Time ×
        Tx_byte count) + (Protocol_Seq_OH_Time × Rx_byte count)
Calculate Channel Idle time:
    Idle_Time = Measure_time − Non_Idle_Time
Calculate Channel Idle time ratio:
    Idle_Time_Ratio = Idle_Time/Non_Idle_Time
For i = 1 to n Loop (as long as no indication of stoppage)
    Calculate Linkₙ Effective Rates:
        Effective_Tx_Rateₙ = Tx_Byte_Countₙ / Measurement_Time
        Effective_Rx_Rateₙ = Rx_Byte Countₙ / Measurement Time
    Calculate Linkₙ Headroom Rates:
        Tx_Headroom_Rateₙ = Effective_Tx_Rateₙ ×
        Idle_Time_Ratio
        Rx_Headroom_Rateₙ = Effective_Rx_Rateₙ ×
        Idle_Time_Ratio
```

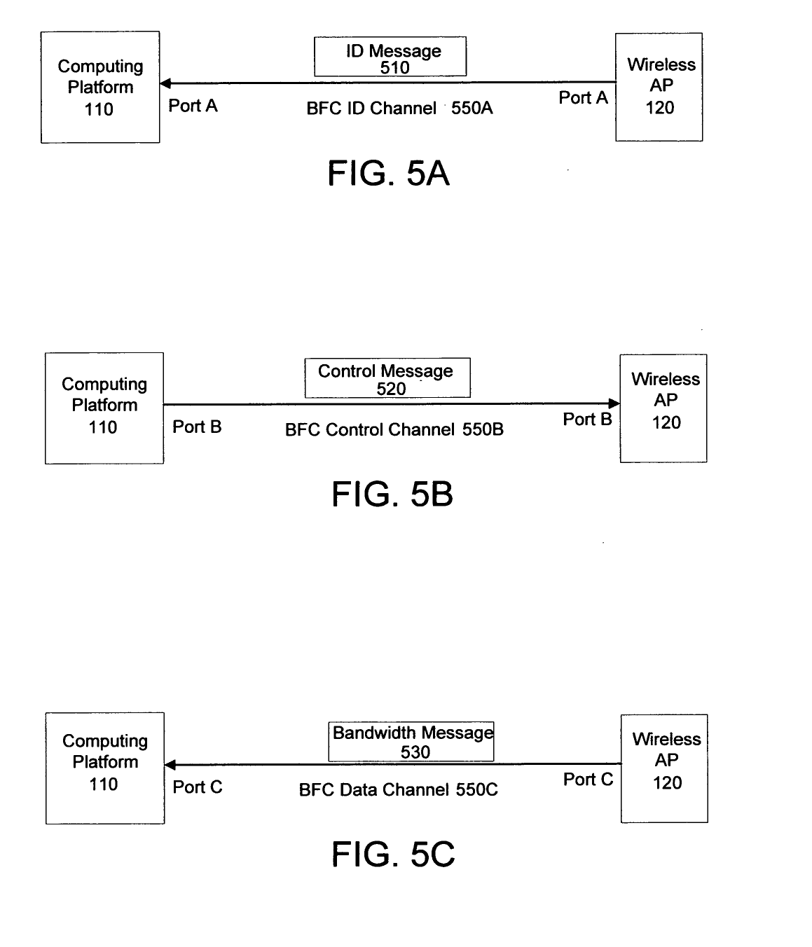

FIGS. 5A-C depict example communication channels included as part of BFC 150 between computing platform 110 and wireless AP 120 in system 100. As briefly mentioned above, in one example, BFC 150 is used by PAM logic 124 to indicate available bandwidth to SQM logic 118. In one example, BFC 150 is built on a standard socket/protocol stack (e.g., Windows™ or Linux Ethernet). Each of the communication channels, for example, include opening a socket session at a given port to establish and maintain a respective communication channel.

In FIG. 5A, an example BFC identification (ID) channel 550A is depicted. In one implementation, BFC ID Channel 550A is a simplex (one-way) communication channel from wireless AP 120 to possible receivers of bandwidth information. The receiver, for example, is depicted in FIG. 5 as computing platform 110.

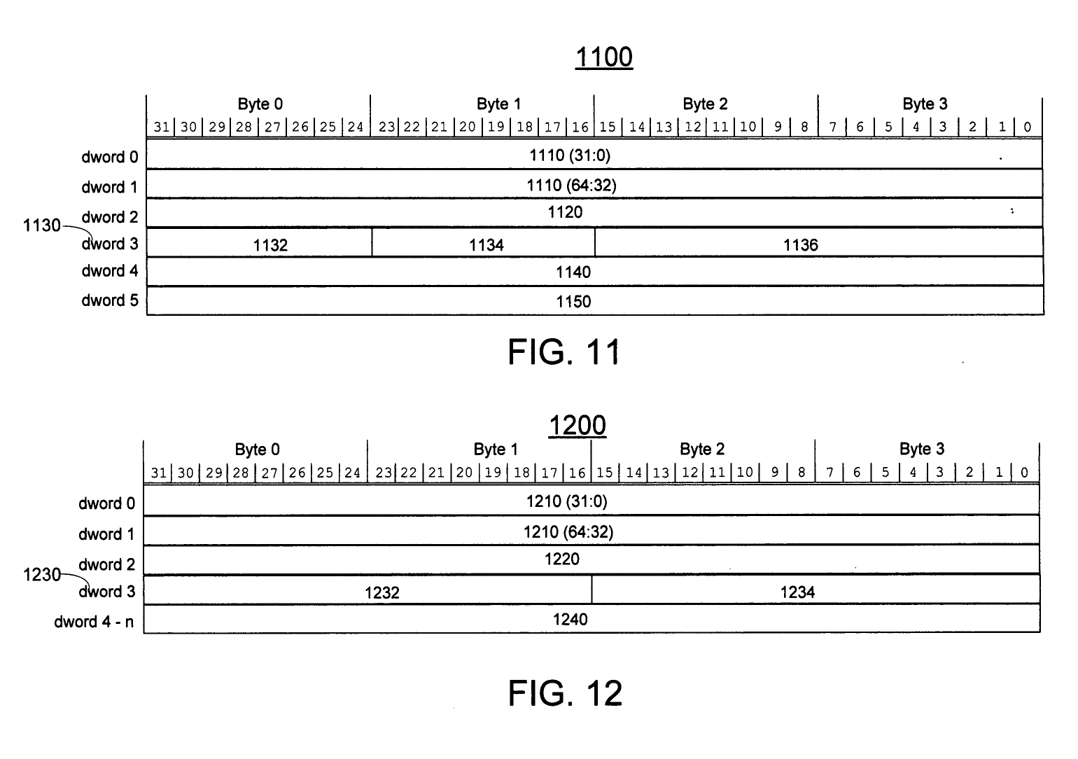

In one example, BFC ID Channel 550A is used for device discovery by the possible receivers of bandwidth information (e.g., computing platform 110 or other computing platforms). A user datagram protocol (UDP), multicast, message, for example, is transmitted from a given communication port (e.g., port A) at wireless AP 120 at regular intervals that are controlled by a programmable timer (not shown). This transmitted message is portrayed in FIG. 5A as ID message 510. The format and possible contents of ID message 510 are described in more detail when describing FIG. 11.

In FIG. 5B, an example BFC control channel 550B is depicted. In one example, BFC control channel 550B is a simplex communication channel from receivers of bandwidth information (e.g., computing platform 110) to wireless AP 120. In one implementation, computing platform 110 establishes a point-to-point transmission control protocol (TCP) session with PAM logic 124 that may include a TCP server (not shown) running on or hosted by PAM logic 124 in wireless AP 120. A control message, for example, depicted in FIG. 5B as control message 520, is transmitted from port B at computing platform 110 to port B at wireless AP 120. The format and possible contents of control message 520 are described in more detail when describing FIG. 12.

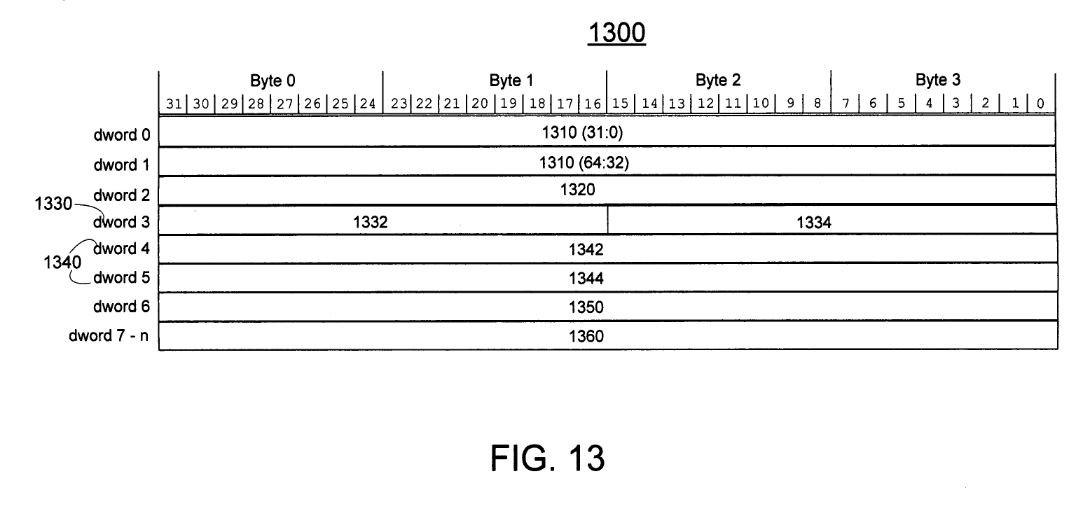

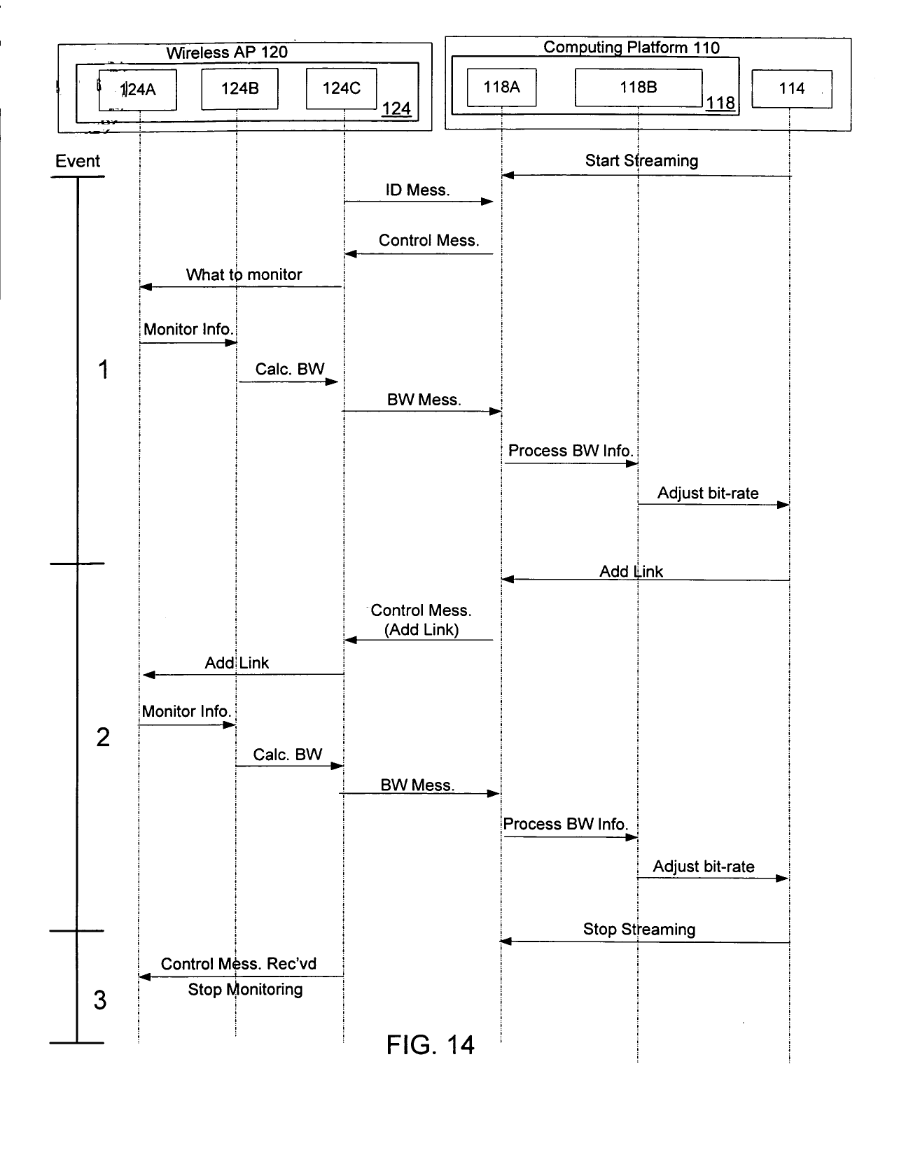

In FIG. 5C, an example BFC data channel 550C is depicted. In one implementation, BFC data Channel 550C is a simplex communication channel from wireless AP 120 to possible receivers of bandwidth information or data (e.g., computing platform 110 or other computing platforms). In one example, BFC data channel 550C is used to transmit messages that include available bandwidth information. A UDP, multicast, message, for example, is transmitted from a given communication port (e.g., port C) at wireless AP 120 at regular intervals that are controlled by a programmable timer (not shown). This transmitted message is portrayed in FIG. 5C as bandwidth message 530. The format and possible contents of bandwidth message 530 are described in more detail when describing FIG. 13.

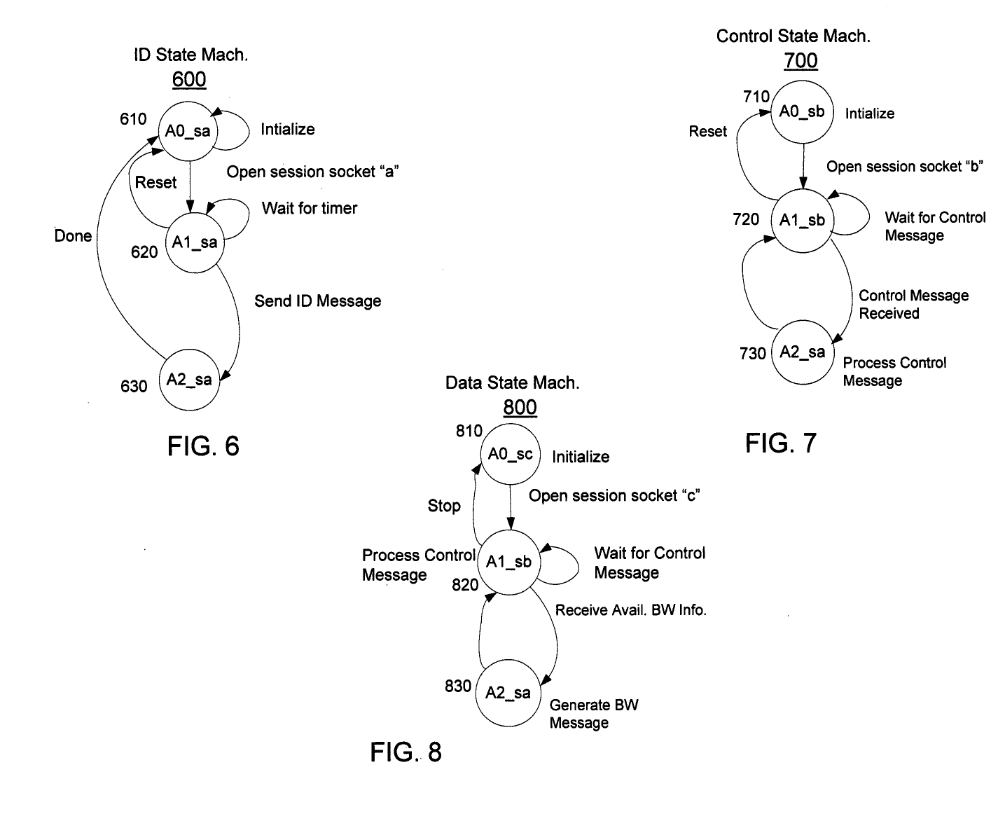

FIGS. 6-8 are diagrams that depict example state machines executed by a wireless AP (e.g., wireless AP 120) to establish and maintain a bandwidth feedback communication channel (e.g., BFC 150) with a computing platform (e.g., computing platform 110). In one implementation, these state machines are executed by communicate feature 124C of PAM logic 124 and include identification (ID) state machine 600 (see FIG. 6) to establish and maintain BFC ID channel 550A, control state machine 700 (see FIG. 7) to establish and maintain BFC control channel 550B and data state machine 800 (see FIG. 8) to establish and maintain BFC data channel 550C.

In one implementation, at point 610, ID state machine 600 depicts communicate feature 124C beginning at state A0_{—}sa following a power-on initiation or a hard reset condition at wireless AP 120. Also in parallel to state A0_{—}sa, for example, are two more states that are portrayed at point 710 as state A0_{—}sb in FIG. 7 and at point 810 as state A0_{—}sc in FIG. 8.

In one example, ID state machine 600 depicts a transition to state A1_{—}sa at point 620 as a session socket “a” is opened. At point 620 and while in state A1_{—}sa, communicate feature 124C sends or transmits an ID message (e.g., ID message 510) for computing platform 110 to identify wireless AP 120 as a provider of available bandwidth information. As shown at point 620, in one example, a timer may be initiated by communicate feature 124C to wait for a response to the transmit ID message. ID State machine 600, for example, at point 630 transitions to state A2_{—}sa based on a response to the transmit ID message, processes the response and then transitions back to state A1_{—}sa to transmit another ID message and wait for a response.

In one implementation, control state machine 700 depicts a transition to state A1_{—}sb at point 720 as a session is opened at socket “b”. At point 720 and while in state A1_{—}sb, for example, communicate feature 124C waits for a control message (e.g., control message 520) from computing platform 110. That control message, for example, includes information on what portions (e.g., links, Tx/Rx buffers, etc.) of communication channel 140 or other information (e.g., network statistics) are to be monitored and/or collected. As shown at point 720, in one example, communicate feature 124C transitions to state A2_{—}sa to process the control message. At point 730, for example, the control message is processed and communicate feature 124C transitions back to state A1_{—}sb.

In one implementation, control state machine 800 depicts a transition to state A1_{—}sb at point 820 as a session is opened at socket “c”. At point 820 and while in state A1_{—}sb, for example, communicate feature 124C waits for a control message as mentioned above. As shown at point 820, in one example, communicate feature 124C may transition to one of two states. These two states include state A0_{—}sc at point 810 and A2_{—}sa at point 830. At point 820, for example, communicate feature 124 receives a control message (e.g., control message 520) and forwards information to monitor feature 124B to make any necessary modification to what is monitored and/or collected. In one example, from point 820 communicate feature 124B may return to state A0_{—}sc if a control message is received from computing platform 110 that indicates monitoring is to stop.

At point 830, for example, communicate feature 124C receives the results of any available bandwidth calculations completed by bandwidth feature 124B based on information gathered by monitor feature 124A. In one example, communicate feature 124C transitions to state A2_{—}sa to generate a bandwidth message (e.g., bandwidth message 530). This bandwidth message, for example, is transmitted to computing platform 110 to indicate the available bandwidth for the computing platform to adjust the given bit-rate video content is streamed.

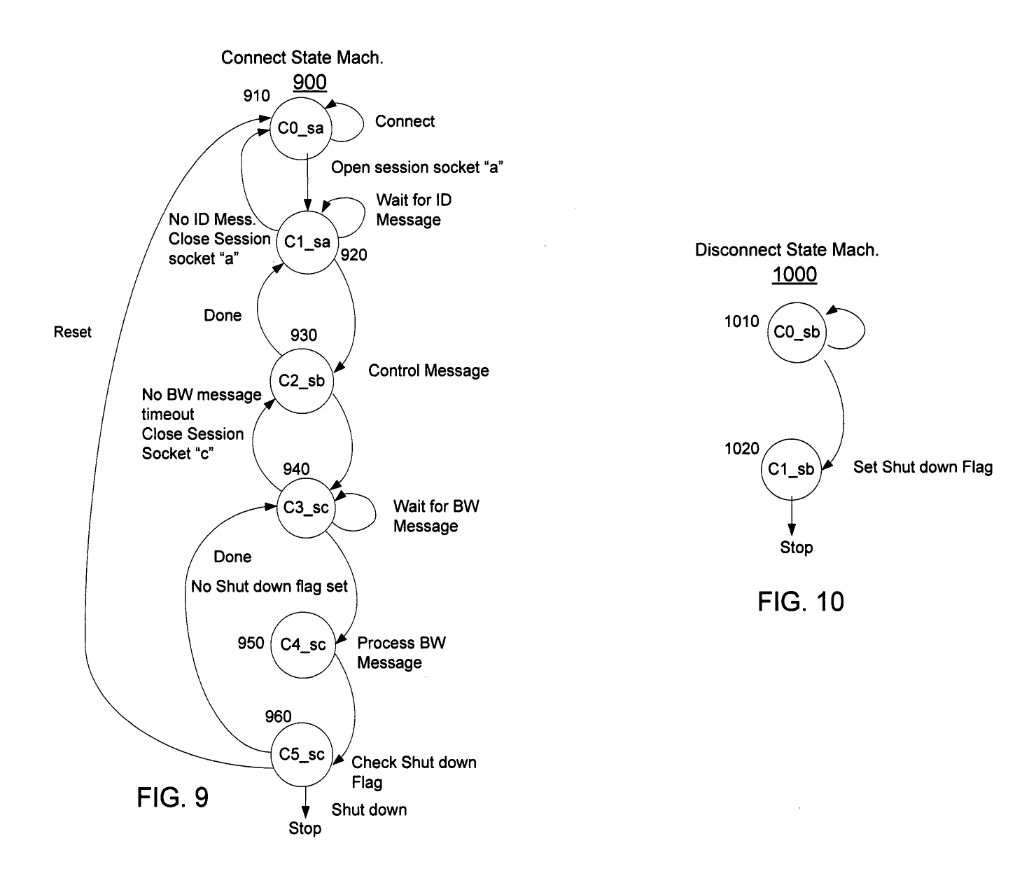

FIG. 9 and FIG. 10 are diagrams that depict example state machines executed by computing platform 110 to establish and maintain BFC 150 with wireless AP 120. In one implementation, these state machines are executed by communicate feature 118A of SQM logic 118 and include connect state machine 900 (see FIG. 9) to establish and maintain all three communication channels included in BFC 150 and disconnect state machine 1000 (see FIG. 10) to end communications with wireless AP 120 via BFC 150.

In one implementation, connect state machine 900 depicts a transition to state C1_{—}sa at point 920 following a session socket “a” opening. At point 920, for example, communicate feature 118A may initiate or activate a timer. The timer may be set for a given time for which communicate feature 118A will wait for an ID message (e.g., ID message 550A) from wireless AP 120. If no ID message is received, for example, communicate feature 118A transitions back to state C0_{—}sa and the session socket “a” is closed.

In one example, at point 930, communicate feature 118A receives the ID message and responds by generating a control message (e.g., control message 550B). Based on this response, communicate feature 118A transitions to state C2_{—}sb. At point 940, for example, communicate feature 118A transitions to state C3_{—}sc and waits to receive a bandwidth message (e.g., bandwidth message 530) from wireless AP 120. This waiting, for example, may include the initiation of a timer. If the time expires before receiving a bandwidth message, for example, communicate feature 118A closes a session socket “c” that was previously opened by wireless AP 120 (see FIG. 8).

At point 950, in one example, a bandwidth message is received before the timer expires and communicate feature 118A transitions to state C4_{—}sc to process the information in the bandwidth message. Communication feature 118A, for example, may relay or make available that information to adjustment feature 118B. Adjustment feature 118B, for example, may cause transcoder/streamer logic 114 to adjust the given bit-rate that video content is streamed from computing platform 110 based on that information.

At point 960, in one example, communicate feature 118A transitions to state C5_{—}sc and at this state checks for an indication to end or stop communications with wireless AP 120 via the communication channels included in BFC 150. A shut down flag, for example, serves as an indication to stop communications if this is the case. In one example, if the shut down flag is asserted then communicate feature 118A takes this as an indication to end communications. If the shut down flag is not asserted, for example, communicate feature 118A transitions back to state C3_{—}sc and waits for additional bandwidth messages. In another example, communicate feature 118A may transition all the way back to state C0_{—}sa if computing platform 110 and/or SQM logic is reset or communications are interrupted with wireless AP 120.

In one implementation, disconnect state machine 1000 in FIG. 10 depicts at point 1010 that communicate feature 118A remains at state D0_{—}sb while computing platform 110 and wireless AP 120 are still communicating via the communication channels included in BFC 150. At point 1020, for example, communicate feature 118A determines or is notified that streaming of the video content from computing platform 110 is done or is to stop. Based on this determination or notification, for example, communicate feature 118A asserts a shut down flag. This shut down flag, as mentioned above, is used as an indication to end or stop communications with wireless AP 120 via the communication channels included in BFC 150.

FIG. 11 illustrates an example message format 1100 for ID message 510. In one example, as mentioned above, ID message 510 contains information for computing platform 110 to discover wireless AP 120 and receive bandwidth information via a communication channel included in BFC 150. Message format 1100, for example, includes fields 1110-1150 in double words (dwords) 0-5.

In one implementation, field 1110 includes a wireless AP's unique identifier or serial number. This unique identifier, for example, is a given 64-bit identifier that is associated with a given wireless AP (e.g., wireless AP 120) and is used for receivers of ID message 510 (e.g., computing platform 110) to uniquely identify that wireless AP to these receivers. In one example, the first 32-bits of the 64-bit identifier are placed in dword 0 and the second 32-bits are placed in dword 1. This 64-bit identifier may be assigned by the wireless AP manufacturer or may be assigned by a network administrator or other entity as the wireless AP is activated.

In one example, field 1120 includes information to indicate the packet size or structure for ID messages. For example, field 1120 indicates the number of dwords included in an ID message in the format of message format 1100. Field 1130, in one example, includes sub-fields 1132, 1134 and 1136. These sub-fields include type, protocol (e.g., UDP, TCP, etc.) and version, information to initiate or open a socket session with the given wireless AP. For example, a socket session is opened between computing platform 110 and wireless AP 120 to establish BFC ID channel 550A based, at least in part, on the information in sub-fields 1132, 1134 and 1136.

In one implementation, field 1140 includes information to indicate a port via which bandwidth messages are transmitted from the wireless AP. Field 1150, for example, includes a network address (e.g., an Internet Protocol (IP) address) for the wireless AP. In one example, computing platform 110 uses this port information to maintain another socket session for BFC data channel 550C.

FIG. 12 illustrates an example message format 1200 for control message 520. In one example, as mentioned above, control message 520 contains information on what portions of communication channel 140 are to be monitored while video content is streamed to a DMA device (e.g., DMA 130) from a computing platform (e.g., computing platform 110). Message format 1200, for example, includes fields 1210-1240 in dwords 0-n, where n depends on the amount of control information. For example, n may be large if several links included in a communication channel are monitored and/or information to indicate what to monitor for each link includes much detail.

In one implementation, field 1210 includes the same identifier information that was included in field 1110 of an ID message in the format of message format 1100. In one example, field 1220 includes information to indicate the packet size or structure for a control message. For example, field 1220 indicates the number of dwords included in a control message in format of message format 1200.

In one example, field 1230, includes sub-fields 1232 and 1234. Sub-field 1232, for example, includes information to indicate the type of control message. Types of control messages may include types that indicate to a wireless AP to either add or delete portions of communication channel 140 to monitor (e.g., add or delete communication links to monitor). In one example, sub-field 1232 may also include an identifier for a computing platform to associate any bandwidth information received with a given control message. This identifier, for example, may be included by a wireless AP in any bandwidth messages sent in response to the given control message. Sub-field 1234, for example, includes information to indicate the version of the protocol to use to decode or interpret control messages.

In one implementation, field 1240 includes information or data to indicate to a wireless AP what is to be monitored. For example, field 1240 may include information associated with a communication link(s) in a communication channel. Communication link information, for example, may include media access controller (MAC) address information for a source of video content (e.g., transmitter) on a communication link and MAC address information for a destination (e.g., receiver). For example, communication link 142 in communication channel 140 (see FIG. 1) has computing platform 110 as the source and wireless AP 120 as the destination and communication link 144 has wireless AP 120 as a source and DMA 130 as the destination.

FIG. 13 illustrates an example message format 1300 for bandwidth message 530. In one example, as mentioned above, bandwidth message 530 is a message generated and transmitted by a wireless AP. Bandwidth message 530, for example, includes information to indicate available bandwidth to a computing platform based on monitored information associated with a communication channel used to stream video content. Message format 1300, for example, includes fields 1310-1360 in dwords 0-n, where n depends on the amount of bandwidth information. For example, n may be large if several communication links included in a communication channel are monitored and bandwidth information for each communication link is included in a single bandwidth message in the format of message format 1300.

In one implementation, field 1310 includes the same identifier information that was included in field 1110 of an ID message in the format of message format 1100. In one example, field 1320 includes information to indicate the packet size or structure for a bandwidth message. For example, field 1320 indicates the number of dwords included in bandwidth message in the format of message format 1300.

In one example, field 1330 includes sub-fields 1332 and 1334. Sub-field 1332, for example, includes information to indicate what control request the bandwidth information is associated with as mentioned above when describing message format 1200 and sub-field 1232. Sub-field 1334, for example, includes information to indicate the version of the protocol to use to decode or interpret bandwidth messages.

In one implementation, field 1340 includes sub-fields 1342 and 1344. In one example, sub-fields 1342 and 1344 contain information to determine the measurement time that a wireless AP has monitored a given communication channel. For example, sub-field 1342 includes a start time stamp for the monitoring and sub-field 1344 includes a stop time stamp for the monitoring.

In one example, field 1350 includes communication channel information. For example, field 1350 may include information to indicate that a given communication link in the monitored communication channel is having the biggest impact on available bandwidth, e.g., has lower available bandwidth when compared to other communication links. Thus, for example the given communication link is a constraining communication link for the communication channel.

In one example, field 1360 includes bandwidth information. For example, bandwidth information that was calculated as described in FIG. 4 by PAM logic 124 for video content streamed on communication channel 140. This information, for example, includes available bandwidth for communication link 142 and/or communication link 144 in communication channel 140.

FIG. 14 is an illustration of wireless AP 120 and computing platform 110 implementing an example method to adjust the bit-rate that video content is streamed from computing platform 110 through wireless AP 120 to DMA 130. As depicted in FIG. 14 an event line serves as a marker to three example events that impact the implementation of the example method. At event 1, for example, transcoder/streamer logic 114 indicates to SQM logic 118 that streaming of video content (e.g., video content at least temporarily stored at memory 112) is about to or already has begun. SQM logic 118, for example, activates communicate feature 118A and adjustment feature 118B. Communicate feature 118A, for example, listens for and/or responds to any ID messages received from a wireless AP through which the video content is streamed. As shown in FIG. 14 and for this example, that wireless AP is wireless AP 120.

In one implementation, as mentioned previously, wireless AP 120 may transmit an ID message at regular intervals. In one example, PAM logic 124 of wireless AP 120 activates communicate feature 124C. Communicate feature 124C, for example, generates or assembles an ID message in the format of message format 1100 and transmits it as a multicast message to any device that may establish a communication channel through wireless AP 120.

Communicate feature 118A, for example, receives the ID message and generates or assembles a control message in the format of message format 1200. This control message, for example, may include information to monitor communication link 142 in communication channel 140. In one example, communication channel 140 is used to stream video content from computing platform 110 to DMA 130 for the video content to be displayed. In one example, a control message is sent at regular intervals to indicate to wireless AP 120 what to monitor and/or what to continue to monitor as the video content is streamed.

In one example, communicate feature 124C of PAM logic 124 receives the control message and PAM logic 124 activates monitor feature 124A and bandwidth feature 124B. Monitor feature 124A, for example, begins to monitor communication link 142 and relays information at regular intervals (e.g., measurement intervals) to bandwidth feature 124B. At each interval, for example, bandwidth feature 124B calculates available bandwidth on communication link 142 based on the information relayed from monitor feature 124A. Communicate feature 124C, for example, generates and transmits a bandwidth message in the format of message format 1300 to indicate the available bandwidth.

In one example, communicate feature 118A of SQM logic 118 receives the bandwidth message and relays or makes available the available bandwidth information to adjustment feature 118B. Adjustment feature 118B, for example, based on the available bandwidths, determines if the bit-rate to stream the video content is to be adjusted and indicates any adjustments needed to transcoder/streamer logic 114.

At event 2, in one example, transcoder/streamer logic 114 receives an indication or determines that it needs available bandwidth information for another communication link in communication channel 140, for example, communication link 144 between wireless AP 120 and DMA 130. Transcoder/streamer logic 114 may indicate this additional communication link to communicate feature 118A. Communicate feature 118A, for example, generates and transmits a control message in the format of message format 1200 that includes information to request that available bandwidth information be provided for both communication link 142 and communication link 144. Communicate feature 124C in PAM logic 124 receives and relays that information to bandwidth feature 124B and monitor feature 124A. Both communication links 142 and 144 are monitored, and the same process as described above for determining and reporting available bandwidth as described for event 1 is followed.

At event 3, in one example, streaming of the video content is stopped or is complete. Transcoder/streamer logic 114, for example, indicates this stoppage to SQM logic 118. SQM logic 118 directs communicate feature 118A to stop transmitting control messages to wireless AP 120. In one example, a control message is generated and sent by communication feature 118A to indicate to PAM logic 124 to stop monitoring or collecting information. PAM logic 124, for example, indicates to monitor feature 124A to stop monitoring or collecting information on communication channel 140.

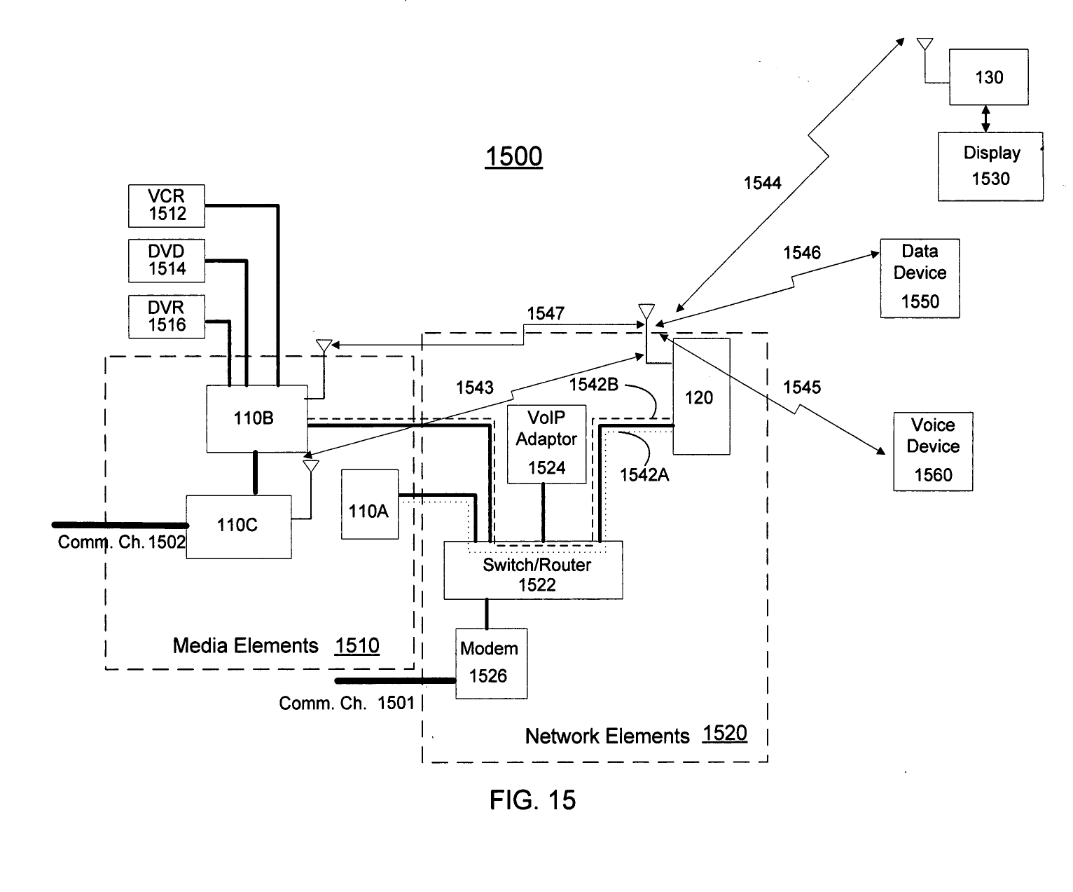

FIG. 15 is an illustration of an example residential network 1500. As depicted in FIG. 15, residential network 1500 includes media elements 1510 and network elements 1520 that are coupled via various wired and wireless communication links. In one implementation, three computing platforms (110A, 110B and 110C) are shown in FIG. 15 as part of media elements 1510. Also, wireless AP 120 is portrayed as part of network elements 1520 and DMA 130 is coupled to or responsive to display 1530. Although not depicted in FIG. 15, in one example, wireless AP 120 and DMA 130 include the same elements described above when describing these elements as part of system 100. Also, computing platforms 110A, 110B and 110C, for example, include at least the same elements described for computing platform 110.

In one example, computing platform 110A is a media server that includes a large amount of storage capacity to store video content (temporarily or longer periods) that is received from elements coupled to residential network 1500. Computing platform 110B, for example, is a media gateway or hub that at least temporarily stores video content that is received from other media devices such as digital video recorder (DVR) 1516, digital video disc (DVD) player 1514, video cassette recorder (VCR) 1512 or from other computing platforms such as computing platform 110C. Computing platform 110C, for example, is a set top box that also at least temporary stores video content. This video content stored at computing platform 110C, for example, is received via communication channel 1502. In one example, communication channel 1502 includes a cable television feed, a satellite television feed or a fiber-optic television feed. This disclosure is not limited to only to the above mentioned types of computing platforms, in other examples a computing platform may be a desktop computer, a laptop computer, a notebook computer, other types of servers, a digital broadband telephony device, a personal digital assistant (PDA) and the like.

In one example, network elements 1520 include components or devices to interconnect other devices in residential network 1500. Network elements 1520 and other components interconnected within residential network 1500 may also receive/transmit data and/or other media content via the Internet through communication channel 1501. In one example, communication channel 1501 is a broadband Internet connection (e.g., cable, fiber-optic, digital subscriber line, broadband wireless, etc.). In this example, residential network 1500 is coupled to the Internet via communication channel 1501 through modem 1526.

In one implementation, modem 1526 couples to switch/router 1522 and this enables devices in residential network 1500 that are interconnected via switch/router 1522 to access the Internet. For example, Voice over Internet Protocol (VoIP) adaptor 1524 makes Internet-based voice calls, computing platforms 110A, 110B and 110C can receive video content, and data device 1550 (e.g., a notebook, desktop, laptop computer, PDA, etc) can receive/transmit data via an interconnection with wireless AP 120 through communication link 1545. Voice device 1560, for example, can make voice calls with or without the use of VoIP adaptor 1524 via an interconnection with wireless AP 120 through wireless communication link 1546.

In one implementation, FIG. 15 depicts several communication channels to stream video content as described above (see FIG. 1). An example communication channel is depicted in FIG. 15 where computing platform 110A is coupled to wireless AP 120 via dotted line 1542A. Dotted line 1542A, for example, passes through switch/router 1522 and represents a wired communication link. Also, wireless AP 120 is coupled to DMA 130 via communication link 1544 that represents a wireless communication link. As described above, a communication channel including either wired or wireless communication links is used to stream video content from a computing platform (e.g., computing platform 110A) to a DMA (e.g., DMA 130) for display. In one example, the display is to be on display device 1530 (e.g., an LCD included in or responsive to a television).

In one example, video content can be streamed from computing platforms 110B and 110C using one of four communication channels. A first communication channel, for example, includes a wireless communication link 1542 between computing platform 110B and wireless AP 120 and then includes wireless communication link 1544 to DMA 130. A second communication channel, for example, is depicted in FIG. 15 as dashed line 1542B and it couples computing platform 110B to wireless AP 120. The second communication channel also includes a wireless communication link 1544 between wireless AP 120 and DMA 130. A third communication channel, for example, includes a wireless communication link 1543 between computing platform 110C and wireless AP 120 and then includes wireless communication link 1544 to DMA 130. A fourth communication channel includes two wireless communication links 1547 and 1544 that couple computing platform 110B to wireless AP 120 and DMA 130, respectively.

In one implementation, wireless AP 120 may establish and maintain a BFC channel (not shown in FIG. 15) with each of computing platforms in residential network 1550. For example, logic within wireless AP 120 (e.g., PAM logic 124) monitors a communication channel used to stream video content at a given bit-rate from a computing platform (e.g., 110A, 110B, 110C) through wireless AP 120 and to DMA 130. The logic, for example, collects information associated with the monitored communication channel to determine available bandwidth and uses the BFC channel to indicate the available bandwidth to the respective computing platform. The respective computing platform, for example, has logic (e.g., SQM 118) that may cause an adjustment to the given bit-rate the video content is streamed from the respective computing platform.

Reference is made again to the types of memory depicted in FIG. 1 that include memory 112, Tx buffers 116A, 122A and 132B and Rx buffers 116B, 122B and 132A. These types of memory may include a wide variety of memory media including, but not limited to, volatile memory, non-volatile memory, flash, programmable variables or states, random access memory (RAM), read-only memory (ROM), flash, or other static or dynamic storage media.

Reference is also made to the types of logic depicted in FIG. 1 that includes transcoder/streamer logic 114, SQM logic 118, PAM logic 124, decoder logic 134 and transmit logic 36. These types of logic may represent any of a wide variety of logic device(s). These logic device(s) may include a microprocessor, network processor, service processor, microcontroller, field programmable gate array (FPGA), application specific integrated circuit (ASIC), or executable content to implement the features described in this disclosure and/or associated with these types of logic, or any combination thereof.

In one example, machine-readable instructions can be provided to the types of logic depicted in FIG. 1 from a form of machine-accessible medium. A machine-accessible medium may represent any mechanism that provides (i.e., stores and/or transmits) information or content in a form readable by a machine (e.g., an ASIC, special function controller or processor, FPGA, or other hardware device). For example, a machine-accessible medium may include: ROM; RAM; magnetic disk storage media; optical storage media; flash memory devices; electrical, optical, acoustical or other form of propagated signals (e.g., carrier waves, infrared signals, digital signals); and the like.

In the previous descriptions, for the purpose of explanation, numerous specific details were set forth in order to provide an understanding of this disclosure. It will be apparent that the disclosure can be practiced without these specific details. In other instances, structures and devices were shown in block diagram form in order to avoid obscuring the disclosure.

References made in this disclosure to the term “responsive to” are not limited to responsiveness to only a particular feature and/or structure. A feature may also be “responsive to” another feature and/or structure and also be located within that feature and/or structure. Additionally, the term “responsive to” may also be synonymous with other terms such as “communicatively coupled to” or “operatively coupled to,” although the term is not limited in his regard.

What is claimed is:

1. A method comprising:
streaming video content at a given bit-rate from a computing platform through a wireless access point and to a digital media adaptor that decodes the video content for display;
monitoring a communication channel used to stream the video content to the digital media adaptor and collect information associated with the communication channel as at least a portion of the video content is streamed from the computing platform to the digital media adaptor;
determining available bandwidth for the communication channel based on the collected information; and
adjusting the given bit-rate that another portion of the video content is streamed from the computing platform based on the available bandwidth.

2. A method according to claim 1, wherein monitoring the communication channel comprises the communication channel including a communication link between the computing platform and another communication link between the wireless access point and the digital media adaptor, the other communication link to include a wireless communication link.

3. A method according to claim 2, wherein to collect information associated with the communication channel comprises to collect information on at least one of the communication link between the computing platform and wireless access point and the other communication link between the wireless access point and the digital media adaptor.

4. A method according to claim 3, wherein the collected information includes:
a byte count of successfully transmitted packets of video content to the digital media adapter over a given amount of time;
a byte count of successfully received packets of video content from the computing platform over the given amount of time;
a non idle time that includes a summation of time used to transmit packets of video content over the given amount of time and time used to receive packets of video content over the given amount of time; and
an idle time that subtracts from the given amount of time the summation of the time used to transmit packets of video content and the time used to receive packets of information.

5. A method according to claim 4, wherein the non idle time that includes the summation of time used to transmit the packets of video content over the given amount of time and time used to receive the packets of information over the given amount of time further comprises the summation to include another summation of:
a first product derived by multiplying a protocol sequence overhead time by the byte count of successfully transmitted packets of video content to the digital media adaptor over the given amount of time, the protocol sequence overhead time based on an overhead time associated with a communication protocol used to transmit the video content to the digital media adaptor; and
a second product derived by another protocol sequence overhead time by the byte count of successfully received packets of video content from the computing platform over the given amount of time, the other protocol sequence overhead time based on an overhead time associated with a communication protocol used to receive the video content from the computing platform.

6. A method according to claim 1, wherein the video content streamed from the computing platform includes a plurality of video image frames compressed into packets of video content using a Motion Picture Expert Group (MPEG) standard, the MPEG standard to include at least one selected from the following of: MPEG-1, MPEG-2 and MPEG-4.

7. A method according to claim 1, further comprising:
establishing another communication channel between the computing platform and the wireless access point; and
using the other communication channel between the computing platform and the wireless access point to indicate the determined available bandwidth to the computing platform for the computing platform to adjust the given bit-rate the other portion of the video content is streamed from the computing platform.

8. A method according to claim 7, wherein the other communication channel further comprises:
an identification communication channel to transmit a message to identify the wireless access point to the computing platform;
a control communication channel to transmit a message to indicate what information to collect associated with the communication channel used to stream the video content; and
a data communication channel to transmit a message to indicate the determined available bandwidth for the communication channel used to stream the video content.

9. A method according to claim 1, wherein the digital media adaptor that decodes the video content for display comprises the display to include at least one display selected from the following of: a liquid crystal display, a projection display, a plasma display and a cathode ray tube display.

10. An apparatus comprising:
a wireless access point including logic, the logic to:
monitor a communication channel used to stream video content from a computing platform through the wireless access point and to a digital media adaptor that decodes the video content for display, the video content streamed at a given bit-rate;
collect information associated with the monitored communication channel and determine available bandwidth to stream the video content using the communication channel based on the collected information; and
indicate the available bandwidth to the computing platform for the computing platform to adjust the given bit-rate the video content is streamed based on the indicated available bandwidth.

11. An apparatus according to claim 10, wherein the wireless access point including logic further comprises the logic to:
establish another communication channel with the computing platform; and
use the other communication channel with the computing platform to indicate the available bandwidth to the computing platform.

12. An apparatus according to claim 11, wherein to establish the other communication channel with the computing platform includes the logic to:
establish an identification communication channel to transmit a message to identify the wireless access point to the computing platform;
establish a control communication channel to receive a message from the computing platform that indicates what information to collect associated with the communication channel used to stream the video content; and
establish a data communication channel to transmit a message to the computing platform to indicate the determined available bandwidth for the communication channel used to stream the video content.

13. An apparatus according to claim 10, wherein to monitor the communication channel used to stream video content comprises the communication channel to include a communication link between the computing platform and the wireless access point and another communication link between the wireless access point and the digital media adaptor, the other communication link to include a wireless communication link.

14. An apparatus according to claim 13, wherein the logic to collect information associated with the communication channel comprises the logic to collect information on at least one of the communication link between the computing platform and wireless access point and the other communication link between the wireless access point and the digital media adaptor.

15. An apparatus according to claim 13, wherein the wireless access point operates in compliance with a wireless local area network (WLAN) standard, the WLAN standard to include Institute for Electrical and Electronic Engineers (IEEE) 802.11.

16. An apparatus according to claim 10, wherein the logic comprises at least one logic selected from the following of: a microprocessor, a network processor, a service processor, a microcontroller, a field programmable gate array (FPGA), an application specific integrated circuit (ASIC) and executable content.

17. An apparatus comprising:
a computing platform to include video content at least temporarily stored at the computing platform and to include logic, the logic to:
receive an indication of available bandwidth to wirelessly stream the video content through an access point and to a digital media adaptor that decodes the video content for display;
cause an adjustment to a given bit-rate to stream at least a portion of the video content based on the indication, wherein another indication of available bandwidth is received and based on the other indication, the logic is to cause the given bit-rate to change to stream another portion of the video content.

18. An apparatus according to claim 17, wherein the computing platform including logic further comprises the logic to:
establish another communication channel with the wireless access point; and
use the other communication channel with the wireless access point to receive indications of available bandwidth to stream the video content from the computing platform.

19. An apparatus according to claim 18, wherein to establish the other communication channel with the wireless access point includes the logic to:
establish an identification communication channel to receive a message from the wireless access point to identify the wireless access point to the computing platform;
establish a control communication channel to transmit a message to the wireless access point to indicate what information to collect associated with the communication channel used to stream the video content; and
establish a data communication channel to receive a message from the wireless access point that indicates the determined available bandwidth for the communication channel used to stream the video content.

20. An apparatus according to claim 17, wherein the logic comprises at least one logic selected from the following of: a microprocessor, a network processor, a service processor, a microcontroller, a field programmable gate array (FPGA), an application specific integrated circuit (ASIC) and executable content.

21. An apparatus according to claim 17, wherein the computing platform includes at least one computing platform selected from the following group of: a media server, a media gateway and a set top box.

22. An apparatus according to claim 17, wherein the video content streamed from the computing platform includes a plurality of video image frames compressed into packets of video content using a Motion Picture Expert Group (MPEG) standard, the MPEG standard to include at least one selected from the following of: MPEG-1, MPEG-2 and MPEG-4.

23. A system comprising:
a computing platform including video content to be streamed at a given bit-rate to a digital media adaptor that decodes the video content for display; and
a wireless access point to include logic, the logic to:
monitor a communication channel used to stream the video content from the computing platform to the digital media adaptor through the wireless access point,
collect information associated with the monitored communication channel and determine available bandwidth to stream the video content over the communication channel based on the collected information, and
indicate the available bandwidth to the computing platform for the computing platform to adjust the given bit-rate the video content is streamed based on the indicated available bandwidth,
wherein the computing platform is to adjust the given bit-rate the video content is streamed based on the indicated available bandwidth.

24. A system according to claim 23, wherein the wireless access point including logic further comprises the logic to:
establish another communication channel with the computing platform; and
use the other communication channel with the computing platform to indicate the available bandwidth to the computing platform.

25. A system according to claim 24, wherein to establish the other communication channel with the computing platform includes the logic to:
establish an identification communication channel to transmit a message to identify the wireless access point to the computing platform;
establish a control communication channel to receive a message from the computing platform that indicates what information to collect associated with the communication channel used to stream the video content; and
establish a data communication channel to transmit a message to the computing platform to indicate the determined available bandwidth for the communication channel used to stream the video content.

26. A system according to claim 23, wherein the logic to monitor the communication channel used to stream video content comprises the communication channel to include a wireless communication link between the computing platform and the wireless access point and another wireless communication link between the wireless access point and the digital media adaptor.

27. A system according to claim 23, wherein the wireless access point operates in compliance with a wireless local area network (WLAN) standard, the WLAN standard to include Institute for Electrical and Electronic Engineers (IEEE) 802.11.
